(19) United States
(12) Patent Application Publication
(10) Pub. No.: US 2026/0176008 A1
(43) Pub. Date: Jun. 25, 2026

(54) OPEN-CLOSE TYPE SPATULA, POWDER-DISPENSING APPARATUS INCLUDING THE SAME, AND METHOD OF CONTROLLING POWDER-DISPENSING APPARATUS

(71) Applicant: SAMSUNG ELECTRONICS CO., LTD., Suwon-si (KR)

(72) Inventors: Minsu CHANG, Suwon-si (KR); Jun-Won JANG, Suwon-si (KR); Hyun Do CHOI, Suwon-si (KR); Ki-Won GYAK, Suwon-si (KR); Won Je CHOI, Suwon-si (KR); Daewoong HAN, Suwon-si (KR)

(73) Assignee: SAMSUNG ELECTRONICS CO., LTD., Suwon-si (KR)

(21) Appl. No.: 19/233,597

(22) Filed: Jun. 10, 2025

(30) Foreign Application Priority Data
Dec. 24, 2024 (KR) 10-2024-0195537

(51) Int. Cl. B65B 1/22; B25J 19/00

(52) U.S. Cl. CPC B65B 1/22; B25J 19/0091

(57) ABSTRACT

A method and apparatus are provided. An open-close type spatula may include: a main body configured to be connected to an end portion of a robot arm; and a pair of scoops connected to the main body and including a collection space that is open in a first direction, wherein the pair of scoops are configured to open a lower portion of the collection space by the pair of scoops rotating, relative to the main body, apart from each other, the lower portion being in a second direction that crosses the first direction, and close the lower portion of the collection space by the pair of scoops rotating, relative to the main body, towards each other and contacting each other.

### CROSS-REFERENCE TO RELATED APPLICATION

This application claims priority from Korean Patent Application No. 10-2024-0195537, filed on Dec. 24, 2024, in the Korean Intellectual Property Office, the disclosure of which is incorporated herein by reference in its entirety.

### BACKGROUND

### 1. Field

Methods and apparatuses consistent with embodiments relate to an open-close spatula, a powder-dispensing apparatus including the same, and a method of controlling the powder-dispensing apparatus.

### 2. Description of Related Art

The task of scooping an appropriate amount of powder from a reagent bottle and dispensing the powder precisely is required in various fields such as materials and cooking. Such a task is performed manually by a person using a spatula but may also be performed using a robot arm. For example, with a dual-robot arm, collecting and dispensing operations may be performed in a manner similar to that of a person by gripping a collection target container with one robot arm and gripping a spatula with the other robot arm.

Said related art is information the inventor(s) acquired during the course of conceiving the present disclosure, or already possessed at the time, and is not necessarily prior art publicly known before the present application was filed.

### SUMMARY

One or more embodiments of the disclosure may address at least the above problems and/or disadvantages and other disadvantages not described above. Also, embodiments of the disclosure are not required to overcome the disadvantages described above, and an embodiment of the disclosure may not overcome any of the problems described above.

According to an aspect of the disclosure, an open-close type spatula may be provided and include: a main body configured to be connected to an end portion of a robot arm; and a pair of scoops connected to the main body and including a collection space that is open in a first direction, wherein the pair of scoops are configured to open a lower portion of the collection space by the pair of scoops rotating, relative to the main body, apart from each other, the lower portion being in a second direction that crosses the first direction, and close the lower portion of the collection space by the pair of scoops rotating, relative to the main body, towards each other and contacting each other.

The open-close type spatula may further include: an elastic body configured to open the lower portion of the collection space by applying an elastic force to the pair of scoops along an axis that crosses the first direction and the second direction such that the pair of scoops separate from each other.

The open-close type spatula may further include: a moving part connected to the pair of scoops, the moving part configured to move with the pair of scoops relative to the main body, and configured to enable the pair of scoops to separate or contact each other depending on a relative position of the moving part with respect to the main body.

The main body may include: a space configured to limit movement of the moving part in at least one direction; and an interference portion configured to interfere with an edge wall of the pair of scoops according to a height of the pair of scoops with respect to the main body, the height being along a vertical axis that includes the second direction, wherein the moving part may be slidable in the space of the main body along the vertical axis, wherein, in a case in which the moving part moves upward in the space along the vertical axis in a third direction that is opposite to the second direction, the pair of scoops may be configured to close the lower portion of the collection space by the interference portion causing the pair of scoops to rotate towards each other, by the interference portion interfering with the edge wall of the pair of scoops.

The open-close type spatula may further include an elastic body configured to cause, based on the moving part moving in the second direction in the space such that the pair of scoops move away from the interference portion, the pair of scoops to separate from each other by applying an elastic force to the pair of scoops along an axis that crosses the first direction and the second direction.

In a first state in which the pair of scoops are in contact with each other, the pair of scoops may be configured to open the lower portion of the collection space by the pair of scoops rotating away from each other, based on a force applied to the pair of scoops due to a lower end of the pair of scoops, in the second direction, touching an external object under the pair of scoops in the second direction, wherein, in a second state in which the pair of scoops are separated from each other while touching the external object, the pair of scoops may be configured to close the lower portion of the collection space by the pair of scoops rotating towards each other based on the pair of scoops separating from the external object.

The open-close type spatula may further include a connecting link, wherein a first side of the connecting link is rotatably connected to the main body, and a second side of the connecting link comprises a cam protrusion that is configured move within a cam groove of the moving part, wherein the cam groove may include: a first stable point that is configured to temporarily catch the cam protrusion; a second stable point that is lower than the first stable point in the second direction and configured to temporarily catch the cam protrusion; a first line having a first end connected to the first stable point, and a second end lower than the second stable point; and a second line having a first end connected to the second stable point, and a second end connected to the second end of the first line, wherein the edge wall of the pair of scoops may be configured to move away from the interference portion in a process in which the cam protrusion sequentially moves from the second line toward the first stable point via the first line, and wherein the edge wall of the pair of scoops may be configured to come in contact with the interference portion in a process in which the cam protrusion sequentially moves from the first stable point toward the second stable point via the first line and the second line.

The open-close type spatula may include a click-action mechanism that is configured to cause the pair of scoops to separate from each other or contact each other.

The moving part may include: a first moving part connected to a first scoop from among the pair of scoops, wherein the first moving part is rotatably connected to the main body; and a second moving part connected to a second scoop from among the pair of scoops, wherein the second moving part is rotatably connected to the main body, wherein the pair of scoops may be further configured to open the lower portion of the collection space by the pair of scoops separating from each other based on an angle between the first moving part and the second moving part increasing, and close the lower portion of the collection space by the pair of scoops contacting each other based on the angle between the first moving part and the second moving part decreasing.

According to an aspect of the disclosure, a powder-dispensing apparatus may be provided and include: an open-close type spatula comprising a pair of scoops, wherein the pair of scoops includes a collection space that is open in a first direction; and a vibrator configured to dispense powder collected in the collection space by applying vibration to the open-close type spatula, wherein the pair of scoops are configured to open a lower portion of the collection space by the pair of scoops moving away from each other, the lower portion being in a second direction that crosses the first direction, and close the lower portion of the collection space by the pair of scoops moving towards each other and contacting each other.

The powder-dispensing apparatus may further include a vibration absorber having a first side connected to a robot arm, and a second side connected to the open-close type spatula, wherein the vibration absorber may be configured to dampen at least a portion of vibration generated by the vibrator from being transmitted to the robot arm by absorbing the vibration of the open-close type spatula.

The powder-dispensing apparatus may further include a direction changer configured to change, by rotating the vibrator, a vibration direction of the vibrator between a horizontal vibration direction and a vertical vibration direction.

The powder-dispensing apparatus may further include a vibration absorber having a first side connected to a robot arm, and a second side connected to the open-close type spatula, wherein the vibration absorber may be configured to dampen at least a portion of vibration generated by the vibrator from being transmitted to the robot arm by absorbing vibration in a front-rear direction of the open-close type spatula and vibration in an up-down direction of the open-close type spatula, and wherein the front-rear direction is parallel to the first direction, and the up-down direction is parallel to the second direction.

The vibration absorber may include: a robot fastening block connected to the robot arm; a spatula fastening block connected to the open-close type spatula; a sliding block slidably connected to one from among the robot fastening block and the spatula fastening block in the front-rear direction, and the sliding block slidably connected to of the other from among the robot fastening block and the spatula fastening block in the up-down direction; a first block elastic body between the robot fastening block and the sliding block; and a second block elastic body between the spatula fastening block and the sliding block.

The vibrator may include: a vibration body configured to transmit the vibration to the open-close type spatula; a driving motor connected to the vibration body and configured to generate first rotational power; and an eccentric rotating body connected to a rotation axis of the driving motor, the eccentric rotating body comprising an eccentric center of gravity with respect to the rotation axis of the driving motor.

The powder-dispensing apparatus may further include a direction changer configured to change, by rotating the vibrator, a vibration direction of the vibrator between a horizontal vibration direction and a vertical vibration direction, wherein the direction changer may include: a direction change motor configured to generate second rotational power; and a power transmission body configured to rotate the vibration body by transmitting, to the vibration body, the second rotational power generated by the direction change motor.

According to an aspect of the disclosure, a method of controlling a powder-dispensing apparatus may be provided and include: moving an open-close type spatula towards an upper portion of a powder to be collected, the open-close type spatula including a pair of scoops, and the pair of scoops including a collection space that is open in a first direction, wherein the pair of scoops are configured to open a lower portion of the collection space by the pair of scoops moving away from each other, the lower portion being in a second direction that crosses the first direction, and wherein the pair of scoops are further configured to close the lower portion of the collection space by the pair of scoops moving towards each other and contacting each other; collecting, by the open-close type spatula, the powder by descending the open-close type spatula; moving the open-close type spatula to a dispensing target container while the open-close type spatula has collected the powder; and dispensing the powder by vibrating the open-close type spatula.

The dispensing the powder may include dispensing the powder in the first direction from the collection space by horizontally vibrating the open-close type spatula.

The collecting the powder may include vertically vibrating the open-close type spatula while the open-close type spatula descends in the second direction.

The method may further include changing a vibration direction of the open-close type spatula.

### BRIEF DESCRIPTION OF DRAWINGS

The above and/or other aspects will be more apparent by describing certain embodiments, taken in conjunction with the accompanying drawings, in which:

FIG. 1 is a diagram illustrating a powder-dispensing apparatus according to an embodiment;

FIG. 2 is a diagram illustrating a process of gripping an open-close type spatula, according to an embodiment;

FIG. 3 is a diagram illustrating an open-close type spatula according to an embodiment;

FIG. 4 is a diagram illustrating an interaction between a cam groove and a cam protrusion, according to an embodiment;

FIG. 5 is a diagram illustrating an operation of an open-close type spatula, according to an embodiment;

FIG. 6 is a diagram illustrating a state in which powder is dispensed using a powder-dispensing apparatus, according to an embodiment;

FIG. 7 is a diagram illustrating a state of entering powder to be collected using a powder-dispensing apparatus, according to an embodiment;

FIG. 8 is an exploded perspective view illustrating a vibration absorber according to an embodiment;

FIG. 9 is a block diagram illustrating a powder-dispensing apparatus according to an embodiment;

FIG. 10 is a flowchart illustrating a method of controlling a powder-dispensing apparatus, according to an embodiment;

FIG. 11 is a diagram illustrating a powder-dispensing apparatus according to an embodiment;

FIG. 12 is a diagram illustrating an open-close type spatula according to an embodiment; and

FIG. 13 is a cross-sectional view illustrating a scoop according to an embodiment.

### DETAILED DESCRIPTION

The following detailed structural and/or functional description is provided as an example only, and various alterations and modifications may be made to the example embodiments. The disclosure is not limited to the example embodiments described herein, and should be understood to include all changes, equivalents, and replacements within the spirit and scope of the disclosure.

Terms, such as “first,” “second,” and the like, may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

As used herein, the singular forms “a,” “an,” and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components, and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, non-limiting example embodiments will be described in detail with reference to the accompanying drawings. When describing the example embodiments with reference to the accompanying drawings, like reference numerals refer to like elements and a repeated description related thereto may be omitted.

The same name may be used to describe an element included in the embodiments described herein and an element having a common function. Unless otherwise mentioned, the descriptions of embodiments of the disclosure may be applicable to the other embodiments of the disclosure and thus, duplicated descriptions may be omitted for conciseness.

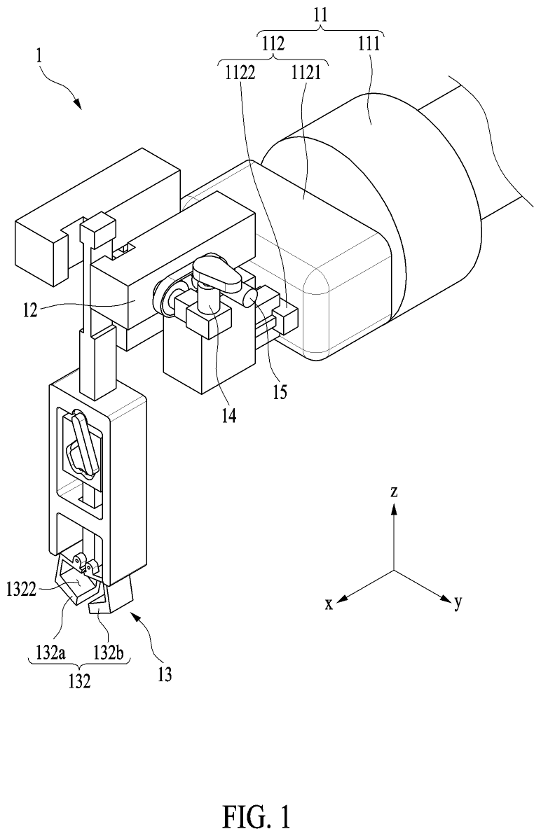

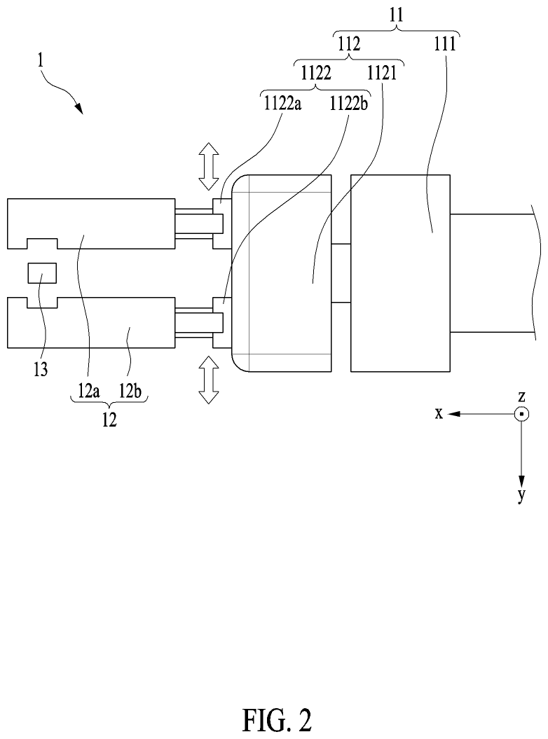

FIG. 1 is a diagram illustrating a powder-dispensing apparatus according to an embodiment. FIG. 2 is a diagram illustrating a process of gripping an open-close type spatula, according to an embodiment.

Referring to FIGS. 1 and 2, according to an embodiment, a powder-dispensing apparatus 1 may perform a task of collecting and/or dispensing powder. The powder-dispensing apparatus 1 may be used in various fields such as an automated material development laboratory, food development, and manufacturing processes. The powder-dispensing apparatus 1 may automate a process of, for example, subdividing a large amount of powder into a small amount of dosing head. The powder-dispensing apparatus 1 may include a robot arm 11, at least one vibration absorber 12, an open-close type spatula 13, a vibrator 14, and a direction changer 15.

The robot arm 11 may move the open-close type spatula 13. The robot arm 11 may move the open-close type spatula 13 with respect to the ground in, for example, a vertical direction and/or a horizontal direction. Although FIG. 1 illustrates that the open-close type spatula 13 is indirectly connected to the robot arm 11 with the vibration absorber 12 connected between the open-close type spatula 13 and the robot arm 11, the open-close type spatula 13 may be directly connected to the robot arm 11. For example, two or more of the robot arm 11, the vibration absorber 12, and the open-close type spatula 13 may be formed integrally. For example, the robot arm 11 may include a joint 111 and an end effector 112.

For example, the robot arm 11 may be a multi-axis robot including a plurality of the joint 111 but is not limited thereto. For example, the robot arm 11 may be a Cartesian robot such as a gantry robot or an XYZ stage robot. For example, when using a Cartesian robot, unlike when using a multi-axis robot, complex orientation motion control of a robot may not be needed, so the amount of control calculation to automate powder collection and/or dispensing work may be reduced, and a working space of the robot arm 11 may be made compact.

The end effector 112 may include a base 1121 connected to an end portion of the robot arm 11, and at least one gripper 1122 connected to (e.g., installed in or on) the base 1121. The gripper 1122 may, for example, slide with respect to the base 1121. For example, the at least on gripper 1122 of the end effector 112 may include a pair of grippers 1122a and 1122b, and the end effector 112 may grip the open-close type spatula 13 by narrowing the gap between the pair of grippers 1122a and 1122b. For example, the at least one vibration absorber 12 may include a pair of vibration absorbers 12a and 12b, and the pair of vibration absorbers 12a and 12b may be connected to (e.g., installed in or on) the pair of grippers 1122a and 1122b, respectively, and as the gap between the pair of vibration absorbers 12a and 12b narrows according to the movement of the pair of grippers 1122a and 1122b, the open-close type spatula 13 may be gripped. Furthermore, according to an embodiment, the pair of grippers 1122a and 1122b may directly grip the open-close type spatula 13 without the vibration absorber 12. For example, the open-close type spatula 13 may be directly fixed to the end effector 112.

The vibration absorber 12 may dampen at least a portion of the vibration generated by the vibrator 14 from being transmitted to the robot arm 11 by absorbing the vibration of the open-close type spatula 13. In a comparative embodiment, during repeated use of a powder-dispensing apparatus, deformation of each component may occur, and such deformation may cause a problem that causes the kinematic equation of the robot arm to be different from what was previously designed. In this case, since the operational accuracy of the robot arm is degraded, calibration of the robot arm may be required, and such calibration work takes a lot of time, which may delay the entire work process. In addition, the vibration transmitted to the robot arm may reduce the durability of the robot arm. According to an embodiment, the vibration absorber 12 may reduce the above-described problem by reducing the transmission of vibration to the robot arm 11 even when the vibration is repeatedly applied to the open-close type spatula 13. For example, one side of the vibration absorber 12 may be connected to the robot arm 11 and the other side of the vibration absorber 12 may be connected to the open-close type spatula 13. For example, the vibration absorber 12 may absorb vibration in the front-rear direction (e.g., an x-axis direction) and/or vibration in the vertical direction (e.g., a z-axis direction) of the open-close type spatula 13, and an example of the structure is described below.

The open-close type spatula 13 may be directly or indirectly (e.g., using the vibration absorber 12 as a medium) connected to the end portion of the robot arm 11. The open-close type spatula 13 may include at least one scoop 132. For example, the at least one scoop 132 may include a pair of scoops 132a and 132b having a collection space 1322 that is open forwardly (e.g., in a +x-axis direction). Due to the pair of scoops 132a and 132b, even when the amount of powder in a collection target container (e.g., a reagent bottle) is small, the powder may be easily collected compared to a spatula with a general shape. The pair of scoops 132a and 132b may open a lower portion of the collection space 1322 in a mutually separated state and may close the lower portion of the collection space 1322 in a mutually contacting state. An example of the structure of the open-close type spatula 13 is described below.

The vibrator 14 may dispense the powder collected in the collection space 1322 by applying vibration to the open-close type spatula 13. The direction changer 15 may change the vibration direction of the vibrator 14 between the horizontal direction (e.g., an x-y plane direction) and the vertical direction (e.g., a z-axis direction) by rotating the vibrator 14. Examples of the structures of the vibrator 14 and the direction changer 15 are described below.

In an embodiment of the powder-dispensing apparatus 1, the powder may be collected and/or dispensed using only one robot arm 11. For example, when a dual-arm robot is used for collecting and/or dispensing powder, by gripping a powder container with any one robot arm and gripping a spatula with the other robot arm, the work may be performed in a manner similar to that of a person using both arms to collect and/or dispense powder. In contrast, according to an embodiment, since the same work may be performed using only one robot arm 11, the space required for the installation and operation of the powder-dispensing apparatus 1 may be reduced and the movement of the robot arm 11 may be simplified.

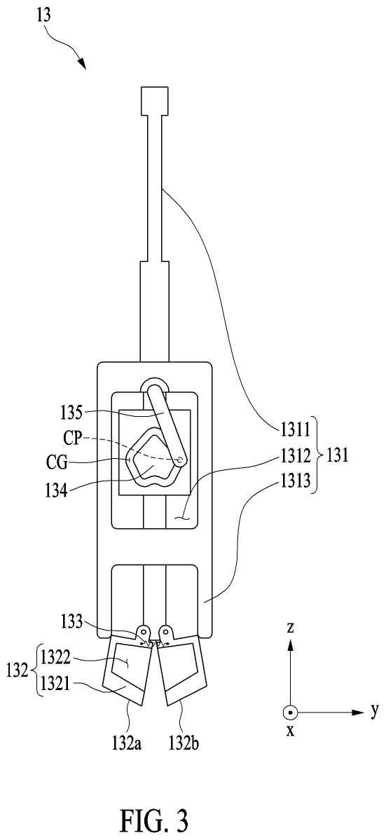

FIG. 3 is a diagram illustrating an open-close type spatula according to an embodiment.

Referring to FIG. 3, according to an embodiment, the open-close type spatula 13 may include a click-action mechanism that allows the pair of scoops 132a and 132b to be mutually separated or contact each other. With this configuration, an open-close state of the open-close type spatula 13 may be changed only by pressing the open-close type spatula 13 against an external object (e.g., powder) under the open-close type spatula 13. Hereinafter, an example of the click-action mechanism is described. The open-close type spatula 13 may include a main body 131, the at least one scoop 132, an elastic body 133, a moving part 134, and a connecting link 135.

The main body 131 may be installed directly or indirectly in an end portion of a robot arm (see the robot arm 11 of FIG. 1). The main body 131 may include a gripping portion 1311, a space 1312, and an interference portion 1313. The gripping portion 1311 may include a groove that may be gripped by a vibration absorber (see the vibration absorber 12 of FIG. 1) or a gripper (see the at least one gripper 1122 of FIG. 1).

The space 1312 may limit the direction in which the moving part 134 may move. The space 1312 may be, for example, a space formed inside the main body 131. The width of the space 1312 may be formed to correspond to the width of the moving part 134, thereby reducing the problem that the moving part 134 moves in the wrong direction while the moving part 134 slides in the vertical direction (e.g., a z-axis direction).

The interference portion 1313 may interfere with an edge wall 1321 of the pair of scoops 132a and 132b according to the height of the pair of scoops 132a and 132b with respect to the main body 131. When the moving part 134 moves upward (e.g., a +z-axis direction) from the state shown in FIG. 3, the interference portion 1313 may apply force (e.g., a force in an inward rotation direction) to the edge wall 1321 of the pair of scoops 132a and 132b, so the pair of scoops 132a and 132b may contact each other so that the lower portion of the collection space 1322 may be closed.

The scoop 132 may include the collection space 1322 that is open forwardly (e.g., a +x-axis direction). The powder collected in the collection space 1322 may be dispensed forward by the vibration in the front-rear direction (e.g., an x-axis direction), which is applied to the scoop 132. The pair of scoops 132a and 132b may each be connected to the main body 131 to be rotatable relative to the main body 131. With this structure, when the pair of scoops 132a and 132b is mutually separated, the lower portion of the collection space 1322 may be opened so that the powder may be collected and/or dispensed. Furthermore, when the pair of scoops 132a and 132b is in contact with each other, the lower portion of the collection space 1322 may be closed so that a state in which the collected powder is accommodated in the collection space 1322 may be maintained. In addition, when an appropriate magnitude of vibration is applied to the open-close type spatula 13 in the front-rear direction while the lower portion of the collection space 1322 is closed, the powder collected in the collection space 1322 may be finely dispensed.

The elastic body 133 may provide elastic force in the direction in which the pair of scoops 132a and 132b is mutually separated. Due to the elastic body 133, when external force is not applied to the pair of scoops 132a and 132b, the lower portion of the collection space 1322 may be opened by opening the pair of scoops 132a and 132b. When the moving part 134 descends downward (e.g., a −z-axis direction) in the space 1312 and the pair of scoops 132a and 132b deviates from the interference portion 1313, the elastic body 133 may provide elastic force in the direction in which the pair of scoops 132a and 132b is mutually separated so that the lower portion of the collection space 1322 may be opened. For example, the elastic body 133 may include a compression spring disposed between the pair of scoops 132a and 132b. For example, the elastic body 133 may include a torsional spring disposed in a hinge in which the moving part 134 and the pair of scoops 132a and 132b are connected to each other.

The moving part 134 may be connected to the pair of scoops 132a and 132b and may move with the pair of scoops 132a and 132b. The moving part 134 may move relative to the main body 131 and may allow (e.g., cause) the pair of scoops 132a and 132b to be mutually separated or contact each other depending on the relative position with respect to the main body 131. The moving part 134 may slide along the longitudinal direction (e.g., a z-axis direction) of the main body 131 in the space 1312. As described above, when the moving part 134 rises upward (e.g., a +z-axis direction) in the space 1312, the pair of scoops 132a and 132b may be rotated by the interference portion 1313 in a mutually contacting direction and may close the lower portion of the collection space 1322. A cam groove CG with which the connecting link 135 is in contact may be formed in the moving part 134.

The connecting link 135 may connect the main body 131 to the moving part 134 and may temporarily restrain the position of the moving part 134 with respect to the main body 131. One side of the connecting link 135 may be rotatably connected to the main body 131, and the other side of the connecting link 135 may be provided with a cam protrusion CP that moves along the cam groove CG formed in the moving part 134.

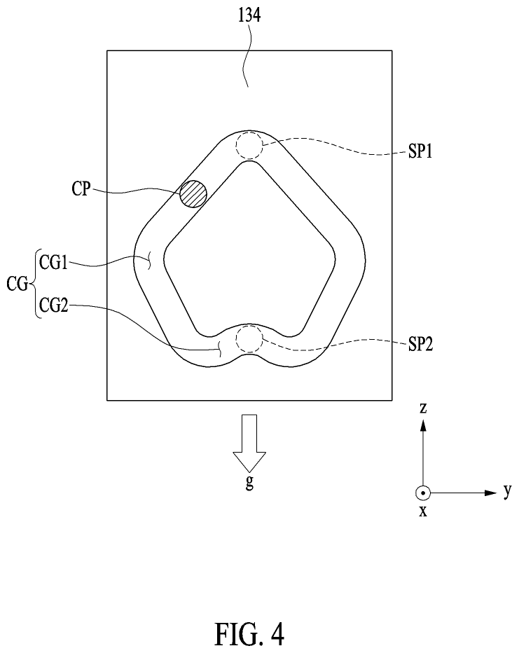

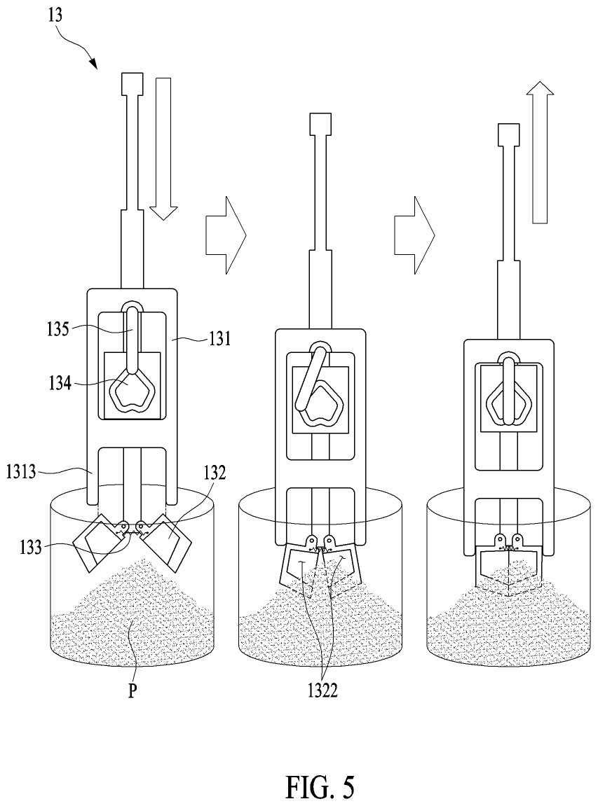

Due to the structures of the cam protrusion CP of the connecting link 135 and the cam groove CG of the moving part 134, the open-close type spatula 13 may be opened and closed according to a click-action mechanism. For example, in a state in which the pair of scoops 132a and 132b is in contact with each other, when a lower end of the pair of scoops 132a and 132b touches an external object (e.g., powder) under the pair of scoops 132a and 132b (e.g., a −z-axis direction) and then is separated, the pair of scoops 132a and 132b may rotate in a direction that opens the lower portion of the collection space 1322. In a state in which the pair of scoops 132a and 132b is mutually separated, when the lower end of the pair of scoops 132a and 132b touches an external object under the pair of scoops 132a and 132b and then is separated, the pair of scoops 132a and 132b may rotate in a direction that closes the lower portion of the collection space 1322. An example of the operation described above is described with reference to FIGS. 4 and 5.

FIG. 4 is a diagram illustrating an interaction between a cam groove and a cam protrusion, according to an embodiment. FIG. 5 is a diagram illustrating an operation of an open-close type spatula, according to an embodiment.

Referring to FIGS. 4 and 5, according to an embodiment, the cam groove CG formed in the moving part 134 may include a first stable point SP1, a second stable point SP2 disposed at a position that is lower than a position of the first stable point SP1, a first line CG1 having one end connected to the first stable point SP1 and another end formed at a position that is lower than the second stable point SP2, and a second line CG2 having one end connected to the second stable point SP2 and another end connected to the other end of the first line CG1.

The cam protrusion CP formed in the connecting link 135 may be temporarily caught on the first stable point SP1. The left sub-diagram of FIG. 5 illustrates a state in which the cam protrusion CP is temporarily caught on the first stable point SP1 and a state in which the moving part 134 descends as much as possible with respect to the main body 131. In this case, the lower portion of the collection space 1322 may be opened.

The first stable point SP1 may be a point of the cam groove CG that is at an upper end of the first line CG1, and the cam groove CG may have a shape that is configured to maintain the cam protrusion CP at the first stable point SP1 while the moving part 134 is biased downward in the direction of gravity g with respect to the cam protrusion CP due to the weight of the moving part 134. Accordingly, based on a state in which the scoop 132 of the open-close type spatula 13 is disposed to face the ground, in a process in which the cam protrusion CP sequentially moves from the second line CG2 toward the first line CG1 and the first stable point SP1, the edge wall 1321 of the scoop 132 may deviate from the interference portion 1313. As a result, in a state in which the cam protrusion CP is positioned at the first stable point SP1, unless another external force is applied to the scoop 132, the lower portion of the collection space 1322 may be maintained in an open state due to elastic restoring force of the elastic body 133.

Furthermore, in the state shown in the left sub-diagram of FIG. 5, when the open-close type spatula 13 descends to a container containing powder P and the scoop 132 touches the powder P, an external force acting upward (e.g., a +z-axis direction) may be applied to the scoop 132. Due to this external force, the moving part 134 may rise with respect to the main body 131, and as shown in the central sub-diagram of FIG. 5, the cam protrusion CP may move in a direction away from the first stable point SP1 along the first line CG1. In this way, as the moving part 134 rises with respect to the main body 131, the scoop 132 may collect the powder P while rotating in a direction that closes the lower portion of the collection space 1322. In a state in which the open-close type spatula 13 moves downward sufficiently and the cam protrusion CP moves to a lower end of the first line CG1, when the open-close type spatula 13 rises again, the cam protrusion CP may move to the second stable point SP2 along the second line CG2, as shown in the right sub-diagram of FIG. 5. That is, based on a state in which the scoop 132 of the open-close type spatula 13 is disposed to face the ground, in a process in which the cam protrusion CP sequentially moves from the first stable point SP1 toward the first line CG1, the second line CG2, and the second stable point SP2, the edge wall 1321 of the scoop 132 may be interfered with by the interference portion 1313 so that the pair of scoops 132 may rotate in a direction such that the pair of scoops 132 may contact each other.

The second stable point SP2 may be a point of the cam groove CG that is at an upper end of the second line CG2, and the cam groove CG may have a shape that is configured to maintain the cam protrusion CP at the second stable point SP2 while the moving part 134 is biased downward in the direction of gravity g with respect to the cam protrusion CP due to the weight of the moving part 134. As a result, the lower portion of the collection space 1322 may be maintained closed while the cam protrusion CP is positioned at the second stable point SP2. Accordingly, a robot arm (see the robot arm 11 of FIG. 1) may move the open-close type spatula 13 to a dispensing target container while the powder P is accommodated in the collection space 1322.

Furthermore, before performing the collection operation, when the open-close type spatula 13 is in the state as shown in the right sub-diagram of FIG. 5, the lower portion of the collection space 1322 of the open-close type spatula 13 may be opened in the reverse order of the above-described process. In the state as shown in the right sub-diagram of FIG. 5, when the open-close type spatula 13 descends and the scoop 132 touches an external object (e.g., the powder P) under the open-close type spatula 13, external force acting upward (e.g., a +z-axis direction) may be applied to the scoop 132. Due to this external force, the moving part 134 may rise with respect to the main body 131, deviate from the second stable point SP2, and move to a lower end of the second line CG2. In this state, when the open-close type spatula 13 rises again, as shown in the central sub-diagram of FIG. 5, the cam protrusion CP may move to the first stable point SP1 along the first line CG1, and finally, the lower portion of the collection space 1322 may be opened as shown in the left sub-diagram of FIG. 5.

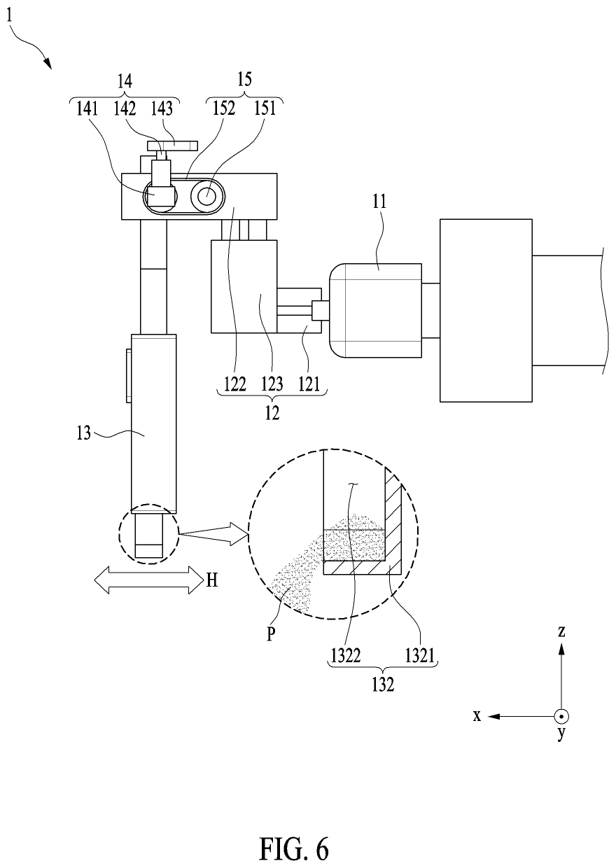

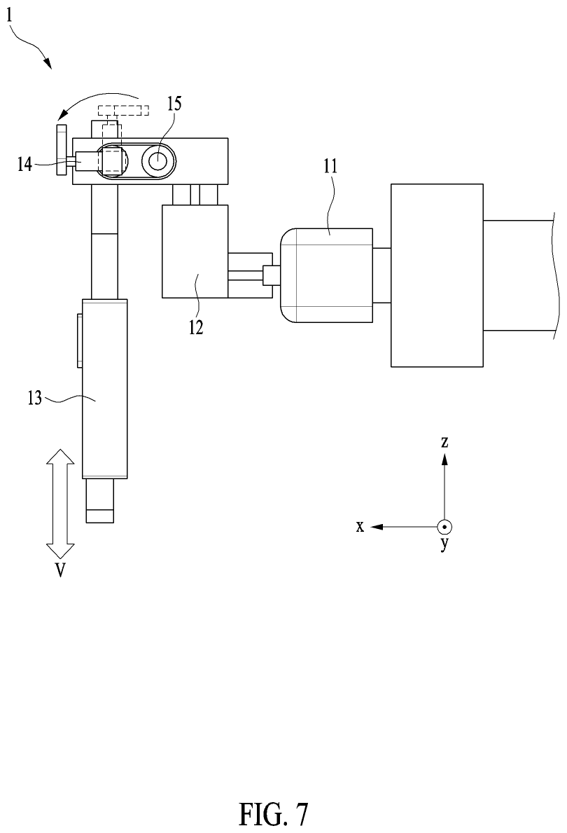

FIG. 6 is a diagram illustrating a state in which powder is dispensed using a powder-dispensing apparatus, according to an embodiment. FIG. 7 is a diagram illustrating a state of entering powder to be collected using a powder-dispensing apparatus, according to an embodiment.

Referring to FIGS. 6 and 7, according to an embodiment, the vibrator 14 may dispense the powder P in the front (e.g., a +x-axis direction) of the collection space 1322 by vibrating the open-close type spatula 13 in a horizontal direction H (e.g., an x-y plane direction). When the powder P is dispensed, there may be a possibility that a vibration component in a vertical direction V (e.g., a z-axis direction) may interfere with fine dispensing by pumping the powder P. According to an embodiment, the vibrator 14 may vibrate the open-close type spatula 13 in the horizontal direction H, which may reduce such a problem. For example, the vibrator 14 may be connected to (e.g., installed in or on) the vibration absorber 12. The vibrator 14 may include a vibration body 141 transmitting vibration to the open-close type spatula 13, a driving motor 142 connected to (e.g., installed in or on) the vibration body 141 and generating rotational power, and an eccentric rotating body 143 connected to (e.g., installed in or on) a rotation axis (e.g., an axel) of the driving motor 142 and having an eccentric center of gravity with respect to the rotation axis.

The driving motor 142 may generate rotational power centered on the rotation axis in a direction that is parallel to the longitudinal direction (e.g., a z-axis direction) of the open-close type spatula 13. The eccentric rotating body 143 may generate vibration in a plane (e.g., an x-y plane) that is perpendicular to the rotation axis by rotating around the rotation axis of the driving motor 142. According to this vibration, the powder P may be finely dispensed to the front (e.g., a −x-axis direction) of the collection space 1322. For example, by controlling the current applied to the driving motor 142 or adjusting the eccentricity of the eccentric rotating body 143, the amount of powder P dispensed from the open-close type spatula 13 may be controlled while the lower portion of the collection space 1322 is closed.

Furthermore, the vibrator 14 may also generate vibration using a linear motor or the like that generates vibration in a straight direction instead of using the eccentric rotating body 143.

According to an embodiment, the direction changer 15 may change the vibration direction of the open-close type spatula 13. For example, the vibrator 14 may be connected to (e.g., installed in or on) the vibration absorber 12. The direction changer 15 may include a direction change motor 151 that generates rotational power, and a power transmission body 152 that rotates the vibration body 141 by transmitting, to the vibration body 141, the rotational power generated by the direction change motor 151.

The rotation axis of the direction change motor 151 may be disposed in a direction that is perpendicular to the rotation axis of the driving motor 142. The vibration body 141 may be rotated by driving the direction change motor 151. For example, as shown in FIG. 7, when the rotation axis of the driving motor 142 is disposed in a plane (e.g., an x-y plane) that is perpendicular to the longitudinal direction of the open-close type spatula 13, vibration may be generated in a direction (e.g., a y-z plane direction) that is parallel to the longitudinal direction of the open-close type spatula 13 by driving the driving motor 142. According to this configuration, in the process of descending the open-close type spatula 13 to collect the powder P, by vibrating the open-close type spatula 13 in the vertical direction V with respect to the ground, the open-close type spatula 13 may be easily penetrated into the powder P through an effect similar to a drill even when the powder P is hardened.

The power transmission body 152 may be, for example, a belt, but various means capable of transmitting rotational power, such as a gear structure, may also be used.

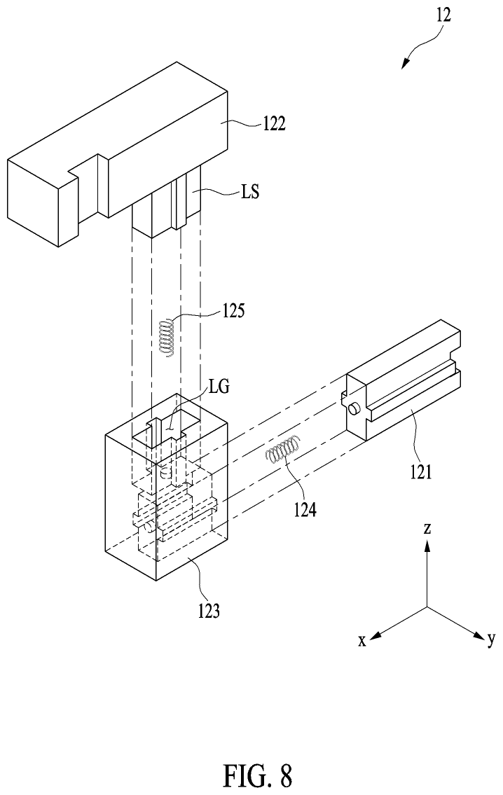

FIG. 8 is an exploded perspective view illustrating a vibration absorber according to an embodiment.

Referring to FIG. 8, according to an embodiment, the vibration absorber 12 may reduce the problem of unnecessary vibration being transmitted to a robot arm (see the robot arm 11 of FIG. 1) by absorbing vibration in the front-rear direction (e.g., an x-axis direction) and/or vibration in the vertical direction (e.g., a z-axis direction) of the open-close type spatula 13. For example, the vibration absorber 12 may have a rigid structure in a direction (e.g., a y-axis direction) in which a gripper (see the gripper 1122 of FIG. 2) slides on the robot arm and may dampen vibration as described above without decreasing the gripping force by the gripper 1122.

The vibration absorber 12 may include a robot fastening block 121 connected to the robot arm 11, a spatula fastening block 122 connected to the open-close type spatula 13, a sliding block 123 connecting the robot fastening block 121 to the spatula fastening block 122, a first block elastic body 124 connected to (e.g., installed between) the robot fastening block 121 and the sliding block 123, and a second block elastic body 125 connected to (e.g., installed between) the spatula fastening block 122 and the sliding block 123.

The sliding block 123 may be slidably connected to one (e.g., the robot fastening block 121) from among the robot fastening block 121 and the spatula fastening block 122 in the front-rear direction (e.g., an x-axis direction) and may be slidably connected to the remaining one (e.g., the spatula fastening block 122) from among the robot fastening block 121 and the spatula fastening block 122 in the vertical direction (e.g., a z-axis direction). A linear slider LS protruding in a sliding direction and a linear groove LG recessed in the sliding direction may be separately formed in a pair of blocks that is mutually connected among the robot fastening block 121, the spatula fastening block 122, and the sliding block 123. The linear slider LS may be configured to slide in the linear groove LG in the sliding direction. Through such sliding structures (e.g., the linear slider LS and the linear groove LG), it may be possible to reduce vibration generated from a vibrator (see the vibrator 14 of FIG. 6 or FIG. 7) from being transmitted to the robot arm 11.

For example, as shown in FIG. 6, when vibration in the horizontal direction H is generated by the vibrator 14, the sliding block 123 may slide in the horizontal direction H with respect to the other adjacent block (e.g., the robot fastening block 121), thereby dampening the vibration transmitted to the robot arm 11 while efficiently transmitting the vibration by the vibrator 14 to the open-close type spatula 13.

Similarly, as shown in FIG. 7, when vibration in the vertical direction V is generated by the vibrator 14, the sliding block 123 may slide in the vertical direction V with respect to the other adjacent block (e.g., the spatula fastening block 122), thereby dampening the vibration transmitted to the robot arm 11 while efficiently transmitting the vibration by the vibrator 14 to the open-close type spatula 13.

Furthermore, the vibration absorber 12 may have a structure that dampens vibration in only one direction from among the horizontal direction H and the vertical direction V. For example, the robot fastening block 121 may be slidably connected to the spatula fastening block 122 without the sliding block 123. For example, the robot fastening block 121 and the spatula fastening block 122 may be slidably connected in the front-rear direction or may be slidably connected in the vertical direction.

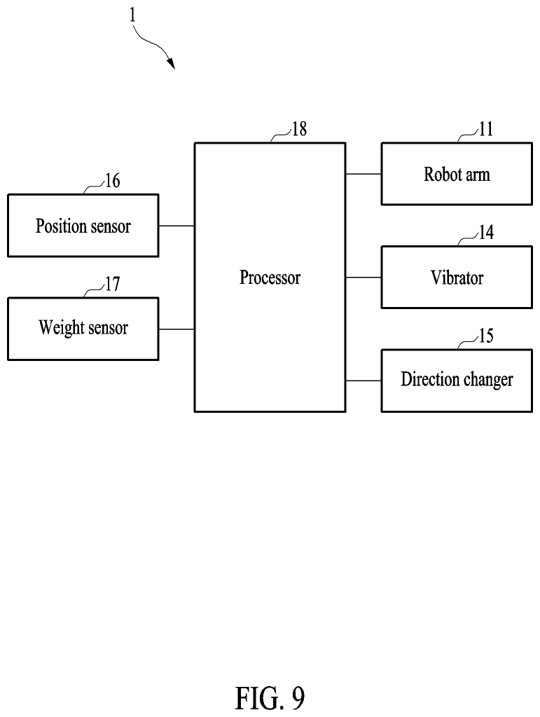

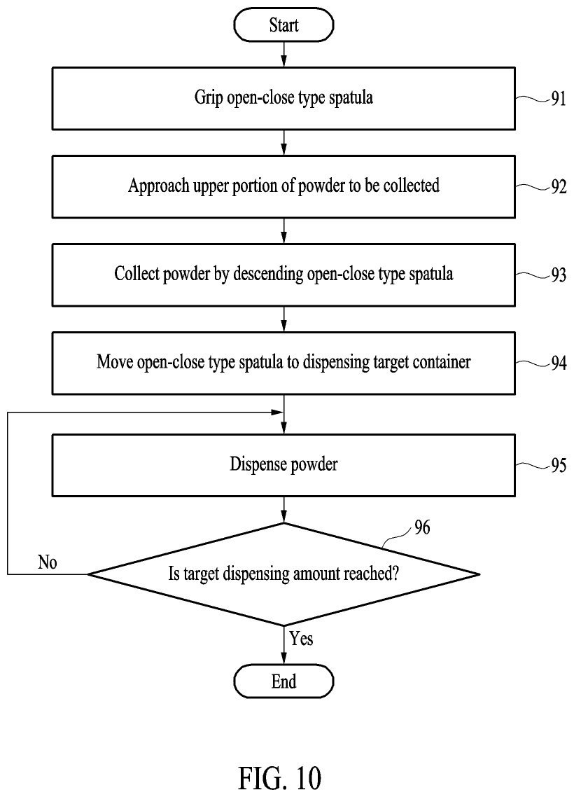

FIG. 9 is a block diagram illustrating a powder-dispensing apparatus according to an embodiment. FIG. 10 is a flowchart illustrating a method of controlling a powder-dispensing apparatus, according to an embodiment.

Referring to FIGS. 9 and 10, according to an embodiment, the powder-dispensing apparatus 1 may include the robot arm 11, an open-close type spatula (see the open-close type spatula 13 of FIG. 1), the vibrator 14, the direction changer 15, at least one position sensor 16, a weight sensor 17, and at least one processor 18.

The at least one position sensor 16 may sense the position of the open-close type spatula 13. For example, the at least one position sensor 16 may be at least one encoder for each joint of the robot arm 11, and the at least one position sensor 16 that may sense the end portion and/or posture of the robot arm 11. The at least one processor 18 may indirectly sense the position of the open-close type spatula 13 based on position information (e.g., an angle value for each joint of the robot arm 11) sensed from the at least one position sensor 16 and shape information of the open-close type spatula 13. For example, the at least one position sensor 16 may be at least one imaging device installed in the robot arm 11 or outside of the robot arm 11 and may directly or indirectly sense the position of the open-close type spatula 13. The at least one processor 18 may sense the position of the open-close type spatula 13 through imaging processing based on the information received from the at least one position sensor 16.

The weight sensor 17 may sense the amount or weight of powder contained in a dispensing target container. The weight sensor 17 may be, for example, a scale on which the dispensing target container is placed. The at least one processor 18 may sense the amount or weight of powder dispensed from the powder-dispensing apparatus 1 to the dispensing target container based on the change in the amount of weight sensed by the weight sensor 17.

The at least one processor 18 may control the robot arm 11, the vibrator 14, and/or the direction changer 15 based on the information received from the at least one position sensor 16 and/or the weight sensor 17. The at least one processor 18 may descend, ascend, and/or move the open-close type spatula 13 based on the information received from the at least one position sensor 16. For example, the at least one processor 18 may include a processor provided in the robot arm 11 and a separate processor capable of wired or wireless communication with the at least one processor 18 of the robot arm 11.

In an embodiment, according to a method of controlling the powder-dispensing apparatus 1, both a collection operation and a dispensing operation may be performed using the open-close type spatula 13 and the single robot arm 11. The method of controlling the powder-dispensing apparatus 1 may include an operation 91 of gripping the open-close type spatula 13, an operation 92 of approaching an upper portion of powder to be collected, an operation 93 of collecting the powder by descending the open-close type spatula 13, an operation 94 of moving the open-close type spatula 13 to a dispensing target container while the open-close type spatula collects the powder, an operation 95 of dispensing the powder by vibrating the open-close type spatula 13, and an operation 96 of determining whether a target dispensing amount is reached. For example, the method of controlling the powder-dispensing apparatus 1 may include changing the vibration direction of the open-close type spatula 13, which may be performed between the operations 93 and 95. Unless otherwise stated, it should be noted that the order of the operations is not limited and some operations may be performed simultaneously.

The operation 91 may include the at least one processor 18 controlling at least one actuator of the end effector 112 to cause the gripper 1122 to grip the open-close type spatula 13.

The operation 92 may include the at least one processor 18 controlling at least one of the joints 111 of the robot arm 11, by controlling at least one actuator of the robot arm 11, to move gripper 1122 and the open-close type spatula 13 towards the upper portion of powder to be collected.

In the operation 93, the at least one processor 18 may vibrate the open-close type spatula 13 in the vertical direction while the open-close type spatula 13 descends. For example, the at least one processor 18 may drive the vibrator 14 by controlling the direction changer 15 in a state in which a posture of the vibrator 14 is changed to a posture that generates vibration in the vertical direction with respect to the ground.

In the operation 95, the at least one processor 18 may dispense powder to the front of the collection space 1322 by vibrating the open-close type spatula 13 in the horizontal direction. For example, by controlling the direction changer 15, the at least one processor 18 may dispense the powder by driving the vibrator 14 in a state in which a posture of the vibrator 14 is changed to a posture that generates vibration in the horizontal direction with respect to the ground.

In the operation 96, the at least one processor 18 may determine whether the amount or weight of the powder dispensed from the powder-dispensing apparatus 1 is reached the target dispensing amount based on the information received from the weight sensor 17. When the target dispensing amount is not reached in the operation 96, the operation 95 may be repeated. When the target dispensing amount is reached in the operation 96, the dispensing operation may be terminated. For example, when the target dispensing amount is not reached in the operation 96 and there is no change in the amount or weight of the dispensed powder sensed by the weight sensor 17, it may be considered that there is no more powder left in the collection space 1322 of the open-close type spatula 13. In this case, the at least one processor 18 may repeatedly perform the operations 92 to 96.

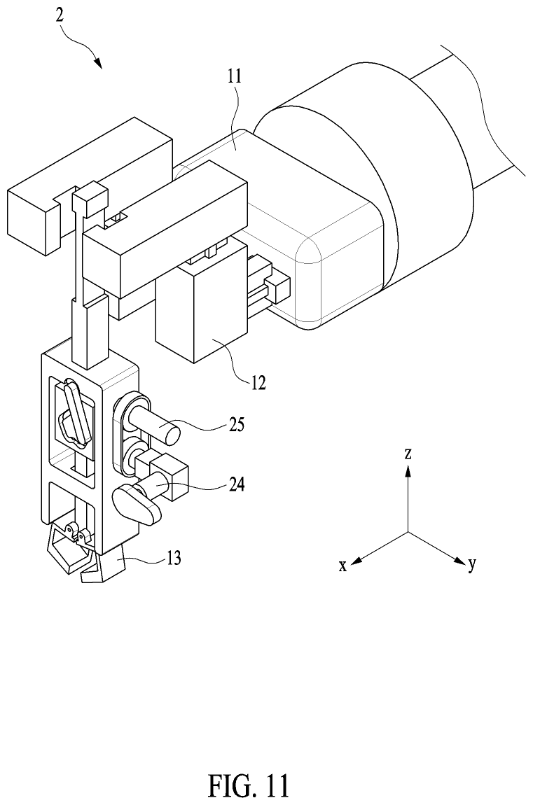

FIG. 11 is a diagram illustrating a powder-dispensing apparatus according to an embodiment.

Referring to FIG. 11, according to an embodiment, a powder-dispensing apparatus 2 may include the robot arm 11, the vibration absorber 12, the open-close type spatula 13, a vibrator 24, and a direction changer 25.

The vibrator 24 and/or the direction changer 25 may be installed in the open-close type spatula 13. With this structure, the efficiency of vibration energy transfer from the vibrator 24 to the open-close type spatula 13 may be improved.

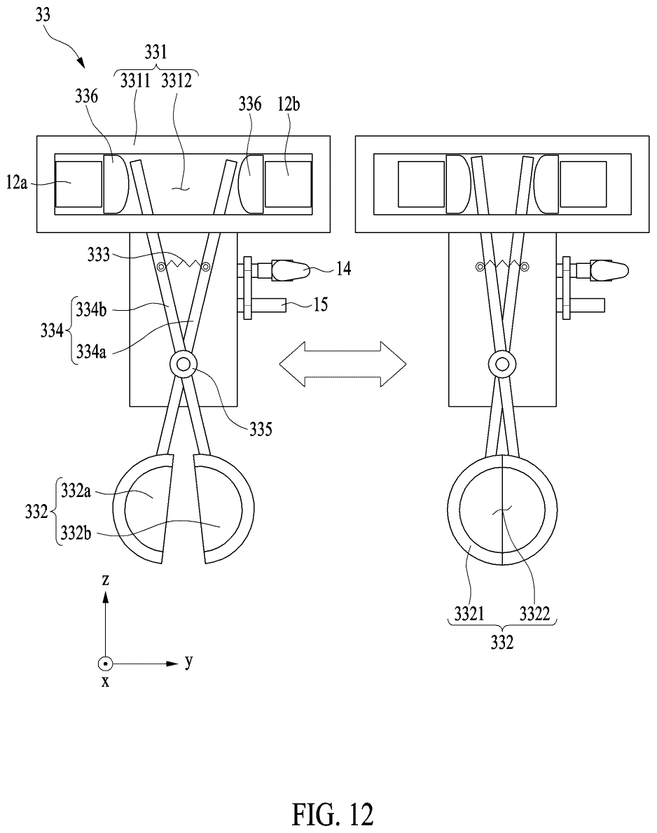

FIG. 12 is a diagram illustrating an open-close type spatula according to an embodiment.

Referring to FIG. 12, according to an embodiment, an open-close type spatula 33 may include a main body 331, at least one scoop 332, an elastic body 333, at least one moving part 334, a connecting hinge 335, and a plunger 336.

The main body 331 may be directly or indirectly installed in an end portion of a robot arm (see the robot arm 11 of FIG. 1). The main body 331 may include a gripping portion 3311 and a space 3312. The gripping portion 3311 may include a groove that may be gripped by the pair of vibration absorbers 12a and 12b. Hereinafter, although an example in which the gripping portion 3311 operates while being gripped by the pair of vibration absorbers 12a and 12b is described, the gripping portion 3311 may also be gripped directly by a gripper (see the pair of grippers 1122a and 1122b of FIG. 2).

The space 3312 may limit the space in which the moving part 334 may move. The space 3312 may be, for example, a space formed inside the main body 331. In the space 3312, the pair of grippers 1122a and 1122b or the pair of vibration absorbers 12a and 12b may move in a mutually separated direction (away from each other) or mutually contacting direction (towards each other) so that the gap between a pair of a first moving part 334a and a second moving part 334b, of the at least one moving part 334, positioned in the space 3312 may be adjusted.

The elastic body 333 may provide elastic force in the direction in which a pair of scoops 332a and 332b, of the at least one scoop 332, are mutually separated. For example, the elastic body 333 may be connected between the pair of the first moving part 334a and the second moving part 334b and may provide elastic force in the direction in which the pair of the first moving part 334a and the second moving part 334b is mutually separated. For example, the elastic body 333 may include a compression spring. For example, the elastic body 333 may also be connected between the pair of scoops 332a and 332b. For example, the elastic body 333 may include a torsional spring disposed in the connecting hinge 335 in which the pair of the first moving part 334a and the second moving part 334b is connected to each other.

The at least one moving part 334 may include the first moving part 334a connected to one (e.g., the scoop 332a) from among the pair of scoops 332a and 332b and rotatably connected to the main body 331, and the second moving part 334b connected to the remaining one (e.g., the scoop 332b) from among the pair of scoops 332a and 332b and rotatably connected to the main body 331.

The plunger 336 may be disposed between the pair of the first moving part 334a and the second moving part 334b and the pair of vibration absorbers 12a and 12b, and may transmit external force to the pair of moving parts 334 according to the movement of the pair of vibration absorbers 12a and 12b. For example, a part of the plunger 336, which contacts the pair of moving parts 334, may have a circular cross-section so that the part may allow the moving part 334 to move smoothly in case the at least one moving part 334 directly contacts the vibration absorbers 12a and 12b.

As shown in the left sub-diagram of FIG. 12, when the gap between the pair of vibration absorbers 12a and 12b increases, the angle between the first moving part 334a and the second moving part 334b may increase due to the elastic restoring force of the elastic body 333. In this case, the scoops 332a and 332b that are respectively connected to the first moving part 334a and the second moving part 334b and operates may be mutually separated so that the lower portion of a collection space 3322 may be opened.

As shown in the right sub-diagram of FIG. 12, when the gap between the pair of vibration absorbers 12a and 12b narrows, the angle between the first moving part 334a and the second moving part 334b may decrease. In this case, the pair of scoops 332a and 332b may contact each other so that the lower portion of the collection space 3322 may be closed.

According to the above-described structure, since it is possible to configure the open-close type spatula 33 relatively simply, the open-close type spatula 33 may be easily cleaned and may be suitable for disposable use.

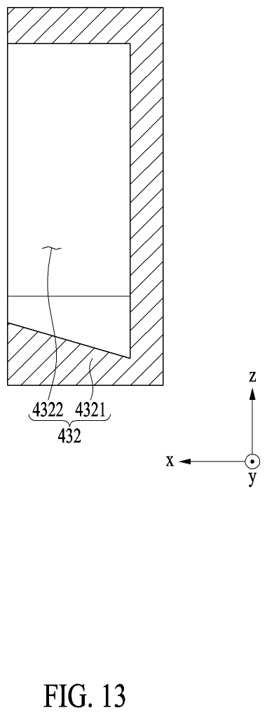

FIG. 13 is a cross-sectional view illustrating a scoop according to an embodiment.

Referring to FIG. 13, according to an embodiment, a scoop 432 may include an edge wall 4321 and a collection space 4322. For example, the height of a bottom portion of the collection space 4322 may increase toward the front (e.g., a +x-axis direction) where the collection space 4322 is open. With this shape, since powder is more stably accommodated in the collection space 4322, the problem of powder loss may be reduced when an open-close type spatula (see the open-close type spatula 13 of FIG. 1) moves from a collection target container to a dispensing target container by using a robot arm (see the robot arm 11 of FIG. 1).

The embodiments described herein may be implemented using a hardware component, a software component, and/or a combination thereof. A processing device may be implemented using one or more general-purpose or special-purpose computers (e.g., a processor, a controller, and an arithmetic logic unit (ALU)), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors. For example, the at least one processor 18 may include the processing device.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

As described above, although non-limiting example embodiments have been described with reference to the drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the example embodiments, including the modifications and variations thereof, are included within the spirt and scope of the disclosure.

What is claimed is:

1. An open-close type spatula comprising:
a main body configured to be connected to an end portion of a robot arm; and
a pair of scoops connected to the main body and comprising a collection space that is open in a first direction,
wherein the pair of scoops are configured to:
open a lower portion of the collection space by the pair of scoops rotating, relative to the main body, apart from each other, the lower portion being in a second direction that crosses the first direction, and
close the lower portion of the collection space by the pair of scoops rotating, relative to the main body, towards each other and contacting each other.

2. The open-close type spatula of claim 1, further comprising:
an elastic body configured to open the lower portion of the collection space by applying an elastic force to the pair of scoops along an axis that crosses the first direction and the second direction such that the pair of scoops separate from each other.

3. The open-close type spatula of claim 1, further comprising:
a moving part connected to the pair of scoops and configured to move with the pair of scoops relative to the main body, and configured to enable the pair of scoops to separate or contact each other depending on a relative position of the moving part with respect to the main body.

4. The open-close type spatula of claim 3, wherein the main body comprises:
a space configured to limit movement of the moving part in at least one direction; and
an interference portion configured to interfere with an edge wall of the pair of scoops according to a height of the pair of scoops with respect to the main body, the height being along a vertical axis that includes the second direction,
wherein the moving part is slidable in the space of the main body along the vertical axis,
wherein, in a case in which the moving part moves upward in the space along the vertical axis in a third direction that is opposite to the second direction, the pair of scoops are configured to close the lower portion of the collection space by the interference portion causing the pair of scoops to rotate towards each other, by the interference portion interfering with the edge wall of the pair of scoops.

5. The open-close type spatula of claim 4, further comprising:
an elastic body configured to cause, based on the moving part moving in the second direction in the space such that the pair of scoops move away from the interference portion, the pair of scoops to separate from each other by applying an elastic force to the pair of scoops along an axis that crosses the first direction and the second direction.

6. The open-close type spatula of claim 4, wherein, in a first state in which the pair of scoops are in contact with each other, the pair of scoops are configured to open the lower portion of the collection space by the pair of scoops rotating away from each other, based on a force applied to the pair of scoops due to a lower end of the pair of scoops, in the second direction, touching an external object under the pair of scoops in the second direction,
wherein, in a second state in which the pair of scoops are separated from each other while touching the external object, the pair of scoops are configured to close the lower portion of the collection space by the pair of scoops rotating towards each other based on the pair of scoops separating from the external object.

7. The open-close type spatula of claim 4, further comprising:
a connecting link, wherein a first side of the connecting link is rotatably connected to the main body, and a second side of the connecting link comprises a cam protrusion that is configured move within a cam groove of the moving part,
wherein the cam groove comprises:
a first stable point configured to temporarily catch the cam protrusion;
a second stable point that is lower than the first stable point in the second direction and configured to temporarily catch the cam protrusion;
a first line having a first end connected to the first stable point, and a second end that is lower than the second stable point; and
a second line having a first end connected to the second stable point, and a second end connected to the second end of the first line,
wherein the edge wall of the pair of scoops is configured to move away from the interference portion in a process in which the cam protrusion sequentially moves from the second line toward the first stable point via the first line, and
wherein the edge wall of the pair of scoops is configured to come in contact with the interference portion in a process in which the cam protrusion sequentially moves from the first stable point toward the second stable point via the first line and the second line.

8. The open-close type spatula of claim 1, wherein the open-close type spatula comprises a click-action mechanism configured to cause the pair of scoops to separate from each other or contact each other.

9. The open-close type spatula of claim 3, wherein the moving part comprises:
a first moving part connected to a first scoop from among the pair of scoops, wherein the first moving part is rotatably connected to the main body; and
a second moving part connected to a second scoop from among the pair of scoops, wherein the second moving part is rotatably connected to the main body, and
wherein the pair of scoops are further configured to:
open the lower portion of the collection space by the pair of scoops separating from each other based on an angle between the first moving part and the second moving part increasing, and
close the lower portion of the collection space by the pair of scoops contacting each other based on the angle between the first moving part and the second moving part decreasing.

10. A powder-dispensing apparatus comprising:
an open-close type spatula comprising a pair of scoops, wherein the pair of scoops comprises a collection space that is open in a first direction; and
a vibrator configured to dispense powder collected in the collection space by applying vibration to the open-close type spatula,
wherein the pair of scoops are configured to:
open a lower portion of the collection space by the pair of scoops moving away from each other, the lower portion being in a second direction that crosses the first direction, and
close the lower portion of the collection space by the pair of scoops moving towards each other and contacting each other.

11. The powder-dispensing apparatus of claim 10, further comprising:
a vibration absorber having a first side connected to a robot arm, and a second side connected to the open-close type spatula,
wherein the vibration absorber is configured to dampen at least a portion of vibration generated by the vibrator from being transmitted to the robot arm by absorbing the vibration of the open-close type spatula.

12. The powder-dispensing apparatus of claim 10, further comprising:
a direction changer configured to change, by rotating the vibrator, a vibration direction of the vibrator between a horizontal vibration direction and a vertical vibration direction.

13. The powder-dispensing apparatus of claim 12, further comprising:
a vibration absorber having a first side connected to a robot arm, and a second side connected to the open-close type spatula,
wherein the vibration absorber is configured to dampen at least a portion of vibration generated by the vibrator from being transmitted to the robot arm by absorbing vibration in a front-rear direction of the open-close type spatula and vibration in an up-down direction of the open-close type spatula, and
wherein the front-rear direction is parallel to the first direction, and the up-down direction is parallel to the second direction.

14. The powder-dispensing apparatus of claim 13, wherein the vibration absorber comprises:
a robot fastening block connected to the robot arm;
a spatula fastening block connected to the open-close type spatula;
a sliding block slidably connected to one from among the robot fastening block and the spatula fastening block in the front-rear direction, and the sliding block slidably connected to of the other from among the robot fastening block and the spatula fastening block in the up-down direction;
a first block elastic body between the robot fastening block and the sliding block; and
a second block elastic body between the spatula fastening block and the sliding block.

15. The powder-dispensing apparatus of claim 10, wherein the vibrator comprises:
a vibration body configured to transmit the vibration to the open-close type spatula;
a driving motor connected to the vibration body and configured to generate first rotational power; and
an eccentric rotating body connected to a rotation axis of the driving motor, the eccentric rotating body having an eccentric center of gravity with respect to the rotation axis of the driving motor.

16. The powder-dispensing apparatus of claim 15, further comprising:
a direction changer configured to change, by rotating the vibrator, a vibration direction of the vibrator between a horizontal vibration direction and a vertical vibration direction,
wherein the direction changer comprises:
a direction change motor configured to generate second rotational power; and
a power transmission body configured to rotate the vibration body by transmitting, to the vibration body, the second rotational power generated by the direction change motor.

17. A method of controlling a powder-dispensing apparatus, the method comprising:
moving an open-close type spatula towards an upper portion of a powder to be collected, the open-close type spatula including a pair of scoops, and the pair of scoops including a collection space that is open in a first direction, wherein the pair of scoops are configured to open a lower portion of the collection space by the pair of scoops moving away from each other, the lower portion being in a second direction that crosses the first direction, and close the lower portion of the collection space by the pair of scoops moving towards each other and contacting each other;
collecting, by the open-close type spatula, the powder by descending the open-close type spatula;
moving the open-close type spatula to a dispensing target container while the open-close type spatula has collected the powder; and
dispensing the powder by vibrating the open-close type spatula.

18. The method of claim 17, wherein the dispensing the powder comprises dispensing the powder in the first direction from the collection space by horizontally vibrating the open-close type spatula.

19. The method of claim 17, wherein the collecting the powder comprises vertically vibrating the open-close type spatula while the open-close type spatula descends in the second direction.

20. The method of claim 17, further comprising:
changing a vibration direction of the open-close type spatula.
